(19) United States
(12) Patent Application Publication
(10) Pub. No.: US 2006/0077170 A1
(43) Pub. Date: Apr. 13, 2006

(54) Driving circuit and multi-display apparatus and electronic device using the same

(75) Inventors: Szu-Hsien Lee, Kaohsiung City (TW); Norio Oku, Taipei City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/243,046

(22) Filed: Oct. 4, 2005

Related U.S. Application Data
(60) Provisional application No. 60/617,357, filed on Oct. 8, 2004.

(51) Int. Cl. G09G 3/36

(52) U.S. Cl. 345/103

(57) ABSTRACT

A driving circuit for multi-panel display and a multi-panel display apparatus and system using the same is provided. The driving circuit comprises a plurality of first driving lines formed on a main panel, a plurality of second driving lines formed on a sub panel and a coupling device. The coupling device comprises an effective coupling module and a dummy coupling module, wherein the effective coupling module electrically couples between each of the second driving lines and a corresponding one of a first part of the first driving lines, and the dummy coupling module electrically couples to a second part of the first driving lines.

### CROSS-REFERENCE TO RELATED APPLICATION

This application claims the priority benefits of U.S. provisional application filed on Oct. 08, 2004, Ser. No. 60/617,357. All disclosure of this application is incorporated herein by reference.

### BACKGROUND OF THE INVENTION

1. Field of Invention

The present invention relates to a driving circuit of a display apparatus. More particularly, the present invention relates to a driving circuit for multi-panel display and multi-display apparatus and electronic device using the same.

2. Description of Related Art

The display characteristics of high definition color displays, include low power consumption, lower voltage requirements and light weight make liquid crystal displays (LCDs) a leading display device technology. LCDs have been used for several years as mobile information displays in, for example, personal digital assistants (PDAs), portable computers, mobile phones, and the like.

Recently, a folding type mobile phone, taking advantage of the advances in fabrication techniques and the desire to display data on front and rear surfaces of the folding portion (or upper housing) thereof, has been developed. A conventional folding type mobile phone utilizes two individual LCDs whose rear surfaces are in contact with each other to achieve a dual-display. However, since the conventional display device uses two individual displays, two sets of electrical equipment for driving the LCDs are required. Therefore, the display device increases in size and weight and the fabrication cost also increases.

For solving the problem of increasing size and weight, some of the driving lines are shared by the two panels. Reference is now made to FIG. 3A, wherein a main display area 400 of a main panel and sub display area 420 of a sub panel share the driving lines in area 402. However, as shown in FIG. 3A, when two panels are different in size, only effective coupling module 410 is used between the main display area 400 and sub display area 420. The main display area comprises a middle part 402 and two side parts 404, 406, wherein the width of the middle part 402 which electrically connected to effective coupling module 410 is corresponding to the width of the sub display area 420. Therefore, the voltages for driving each pixels under the circumstances that all data lines have the same input are changed as shown in FIG. 3B because circuit/voltage characteristics are quite different between the areas 402, 404 and 406. For example, as the signals with the same voltage (e.g., for the same color, white, for example) are input to all the areas 402, 404 and 406, different voltages are generated at the pixels across the main panel 400 after the signals are transmitted in the two display area 400 and 420. This situation occurs because the signal would be reduced or even increased when transmitting via multiplexers or de-multiplexers used in the effective coupling module 410. However, the different voltage changes (decrease or increase) make the screen suffer from flicker.

### SUMMARY OF THE INVENTION

Accordingly, the present invention is to provide an electronic device, a multi-panel display apparatus and a driving circuit for multi-panel display, which compensates the effects of different circuit characteristics across the main panel due to the coupling of the main panel and sub panel. In accordance with the present invention, the effect of coupling between the main panel and sub panel on the variation of voltages across the main panel can be reduced.

One aspect of the present invention is to provide a driving circuit for multi-panel display. The driving circuit comprises a plurality of first driving lines formed on a main panel, a plurality of second driving lines formed on a sub panel and a coupling device. The coupling device comprises an effective coupling module and a dummy coupling module. The effective coupling module electrically couples between each of the second driving lines and a corresponding one of a first part of the first driving lines, and the dummy coupling module electrically couples to a second part of the first driving lines.

Another aspect of the present invention is to provide a multi-panel display apparatus. The multi-panel display apparatus comprises a display driver, a main panel, a sub panel and a coupling device. The display driver generates a driving data to be displayed on the main and/or sub panel. The main panel comprises a plurality of first driving lines electrically coupled to the display driver for receiving the driving data, while the sub panel comprises a plurality of second driving lines electrically coupled to the main panel for receiving at least a part of the driving data. The coupling device comprises an effective coupling module and a dummy coupling module. The effective coupling module electrically couples between each of the second driving lines and a corresponding one of a first part of the first driving lines, and the dummy coupling module electrically couples to a second part of the first driving lines.

Another aspect of the present invention is to provide an electronic device. The electronic device comprises a multi-panel display apparatus described above and an input device, wherein the input device coupled to the display driver of the multi-panel display apparatus to control the multi-panel display apparatus to render an image.

Accordingly, the present invention transmits driving data to the sub panel by using a part of the driving lines transmitting driving data to the main panel. Furthermore, those driving lines, which do not transmit driving data to the sub panel, are coupled to a dummy coupling module having the elements with the same structure of elements in the effective coupling module. Therefore, the driving characteristic of the driving lines are so close that the compensations made on the main panel could be easily designed.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to one embodiment of the present invention.

FIG. 2 is a block diagram of a driving circuit for a multi-panel display according to one embodiment of the present invention.

FIGS. 3A and 3B show a relationship between pixel voltage and data lines according to a fixed driving data input.

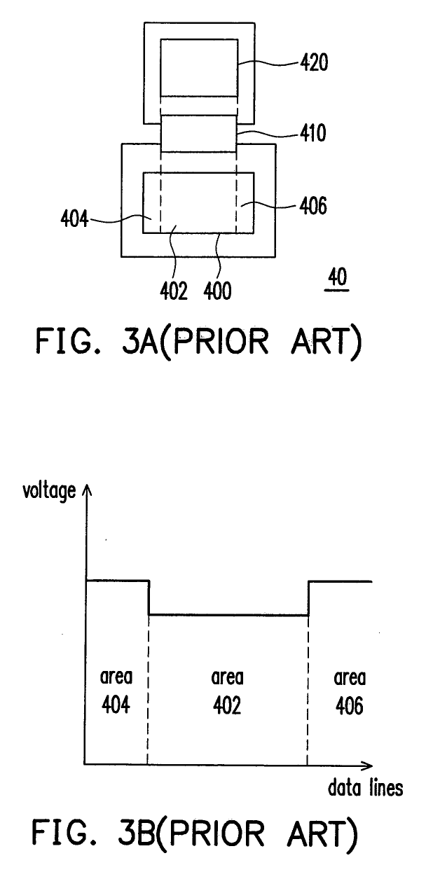

### DESCRIPTION OF THE PREFERRED EMBODIMENTS

Reference will now be made in detail to the embodiments of the present invention, examples of which are illustrated in the accompanying drawings. Wherever possible, the same reference numbers are used in the drawings and the description to refer to the same or like parts.

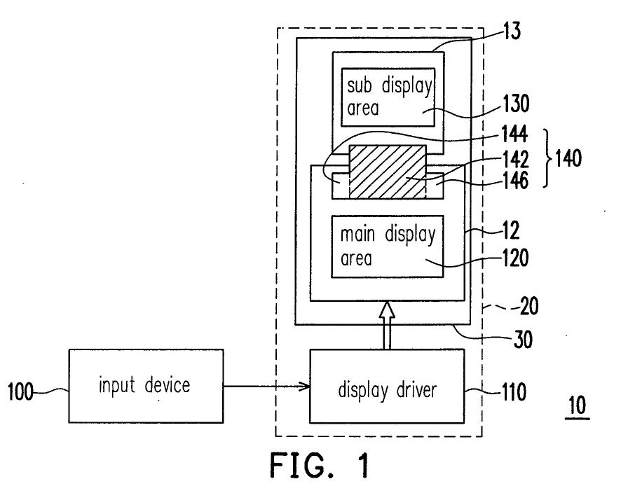

Referring to FIG. 1, which shows a block diagram of a electronic device according to one embodiment of the present invention, the electronic device 10 comprises an input device 100, and a dual-panel display apparatus 20. The electronic device 10 can be a PDA, notebook computer, tablet computer, cellular phone, etc. The dual-panel display apparatus 20 includes a display driver 110, a dual-panel display 30 which comprises a main display area 120 of a main panel 12, a sub display area 130 of a sub panel 13, and a coupling device 140. The input device 100 can be coupled to the display driver 110 and can include a processor or the like to input data to the display driver 110 to render image. The display driver 110 generates and outputs driving data to the main panel 12 to render images in accordance with an input. At least a part of the driving data is transmitted from the main panel 12 to the sub panel 13 via an effective coupling module 142 of the coupling device 140.

Further, the coupling device 140 comprises an effective coupling module 142 and dummy coupling modules 144 and 146. The effective coupling module 142 (shadowed part in the coupling device 140) electrically couples between the sub panel 13 and the main panel 12, and transmits the above mentioned at least a part of driving data from the main panel 12 to the sub panel 13. The dummy coupling modules 144 and 146 only electrically connect to the main panel 12 for providing circuit characteristics, such as capacitance, close to those provided by the effective coupling module 142. Accordingly, the effects of different circuit characteristics across the main panel due to the coupling of the main panel and sub panel are compensated. In accordance with the present invention, the effect of coupling between the main panel and sub panel on the variation of voltages across the main panel can be reduced.

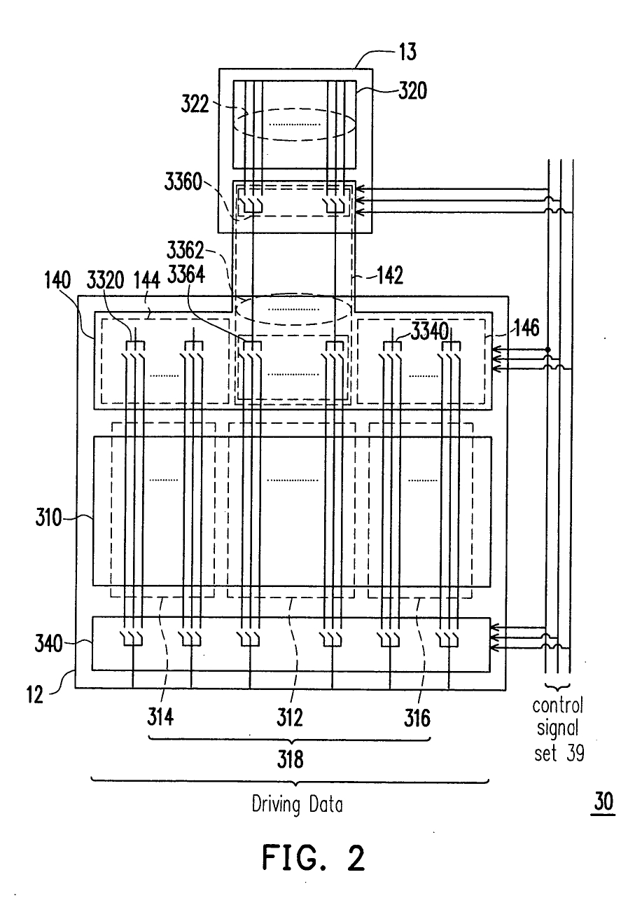

Referring to FIG. 2, which shows a block diagram of a driving circuit for a multi-panel display according to one embodiment of the present invention, the driving circuit for multi-panel display 30 mainly comprises a plurality of first driving lines 318 formed on a main panel 12, a plurality of second driving lines 322 formed on a sub panel 13 and a coupling device 140. The coupling device 140 comprises an effective coupling module 142 and dummy coupling modules 144 and 146. The effective coupling module 142 electrically couples between each of the second driving lines 322 and a corresponding one of a middle part 312 of the first driving lines 318, and the dummy coupling modules 144 and 146 electrically couple to the side parts 314 and 316 of the first driving lines 318.

As shown in FIG. 2, de-multiplexers 3320, 3340 and 3364, which have the same effective circuit/voltage characteristics, are used in dummy coupling modules 144, 146 and effective coupling module 142 respectively. The effective coupling module 142 further comprises a plurality of multiplexers 3360 for coupling to the second driving lines 322, and a plurality of transmitting lines 3362 for coupling between the de-multiplexers 3364 and the multiplexers 3360.

The driving data from display driver 110 (as shown in FIG. 1) are inputted to the first driving lines via a coupling device 340, which comprises a plurality of multiplexers in the embodiment. The control signal set 39 provides control signal from display driver 110 to control the coupling device 140 for selecting which of the middle part 312 of the first driving lines 318 are to receive the driving data. For the same architecture, control signal set 39 can control de-multiplexers and multiplexers in the effective coupling module 142, such as de-multiplexer 3364 and multiplexer 3360, to transmit corresponding part of the driving data to the second driving lines 322. Further, the de-multiplexers in the dummy coupling module 144 and 146, such as de-multiplexer 3320 and 3340, are controlled by the control signal set 39 as well to provide circuit/voltage characteristics of the side parts 314, 316 of the first driving lines 318, which electrically connect to the dummy coupling modules 144 and 146, close to the circuit characteristics of the middle part 312 of the first driving lines 318, which electrically connect to the effective coupling module 336.

Accordingly, the present invention compensates the effects of different circuit characteristics across the main panel due to the coupling of the main panel and sub panel. In accordance with the present invention, the effect of coupling between the main panel and sub panel on the variation of voltages across the main panel can be reduced, therefore the display quality could be improved.

It will be apparent to those skilled in the art that various modifications and variations can be made to the structure of the present invention without departing from the scope or spirit of the invention. In view of the foregoing descriptions, it is intended that the present invention covers modifications and variations of this invention that fall within the scope of the following claims and their equivalents.

What is claimed is:

1. A driving circuit for multi-panel display, comprising:
a plurality of first driving lines formed on a main panel;
a plurality of second driving lines formed on a sub panel; and
a coupling device, comprising an effective coupling module and a dummy coupling module, wherein the effective coupling module electrically couples between each of the second driving lines and a corresponding one of a first part of the first driving lines, and the dummy coupling module electrically couples to a second part of the first driving lines.

2. The driving circuit of claim 1, wherein the effective coupling module and the dummy coupling module comprise elements having substantially similar voltage/circuit characteristics.

3. The driving circuit of claim 1, wherein the effective coupling module comprises:
a plurality of de-multiplexers electrically coupling to the first driving lines;
a plurality of multiplexers electrically coupling to the second driving lines; and
a plurality of transmitting lines, each of the transmitting lines electrically coupled between one of the de-multiplexers and a corresponding one of the multiplexer.

4. The driving circuit of claim 1, wherein the dummy coupling module comprises:
a plurality of de-multiplexers electrically coupling to the first driving lines.

5. The driving circuit of claim 1, wherein the coupling device is controlled by a control signal set.

6. A multi-panel display apparatus, comprising:
an display driver, generating an driving data;
a main panel, comprising a plurality of first driving lines electrically coupled to the display driver for receiving the driving data;
a sub panel, comprising a plurality of second driving lines electrically coupled to the main panel for receiving at least a part of the driving data; and
a first coupling device, comprising an effective coupling module and a dummy coupling module, wherein the effective coupling module electrically couples between each of the second driving lines and a corresponding one of a first part of the first driving lines, and the dummy coupling module electrically couples to a second part of the first driving lines.

7. The multi-panel display apparatus of claim 6, further comprising:
a second coupling device, electrically coupled between the display driver and each of the first driving lines of the main panel for transmitting the driving data to the main panel.

8. An electronic device, comprising:
a multi-panel display apparatus as claimed in claim 6; and
a input device, coupled to the display driver of the multi-panel display apparatus to control the multi-panel display apparatus to render an image.
